(19) United States
(12) Patent Application Publication
(10) Pub. No.: US 2002/0079739 A1
(43) Pub. Date: Jun. 27, 2002

(54) Accessory for sportsperson, vehicle driver or machine operator

(76) Inventor: Michael Grant, Leighton Buzzard (GB)

Correspondence Address: Ohlandt Greeley Ruggiero and Perle L L P, One Landmark Square, 10th Floor, Stamford, CT, 06901-2682, US

(21) Appl. No.: 09/518,030

(22) Filed: Mar. 3, 2000

(30) Foreign Application Priority Data
Mar. 4, 1999 (GB) 9905017.1

(51) Int. Cl. B60L 1/00

(52) U.S. Cl. 307/10.1

(57) ABSTRACT

In order to provide an accessory which can be operated by a sportsperson, vehicle driver or machine operator who cannot readily move their hands away from control means such as a vehicle steering wheel (1), there is a first part (2) which can be operated by a sportsperson, driver or operator, which is mounted on a part of the vehicle, sporting equipment or machine which is normally held by the operator such as the steering wheel (1), and a second part, comprising a receiver (7) for receiving signals from the transmitter and a stopwatch (8) controllable by the receiver. The transmitter transmits signals to the receiver (7) by cableless link, for example infrared.

The present invention relates to an accessory for a sportsperson, vehicle driver or machine operator.

In order to time or measure the performance of rally drivers and their vehicles when racing, it is known to use electronic timing devices. For Example, GB 2 079 989A provides a handheld electronic timing device for use by rally officials by the track side to record the performance of drivers. GB 2 042 775A provides a similar device.

The present inventors have realised that such devices are unsuitable for use by drivers themselves because it will be dangerous for the driver to remove hands from the controls of the car, particularly under very tense racing conditions. Even if the timer is mounted for example on the dashboard, it will still be necessary to remove the hands from the wheel to operate it.

Similarly, devices may be required to measure the performance of sportspersons, for example skiers, snow boarders etc. Such sportspersons will require an accessory which can be mounted where they can see it but may not be able to use their hands to operate such an accessory when it is placed in a position where they can see it.

Some machinery requires users to have their hands more or less permanently in contact with the controls. Such a user may again require an accessory to provide information about time or operation etc. which will need to be placed where the operator can see it, but which the operator will not be able to manipulate when the accessory is placed in a postion where the operator can see it.

U.S. Pat. No. 4,608,550 provides an electronic signal transmission system for a road vehicle in which controls are mounted by the hub of a steering wheel so that the driver does not need to move the hands very far to operate the system. However, the system still requires the driver to remove at least one hand from the steering wheel which may not be possible under rallying conditions. Secondly, a permanent electronic contact is required to allow control signals to be transmitted along the steering column. This requires a complicated modification of the vehicle.

The present inventors have realised that a reliable accessory can be made for a sportsperson, vehicle driver or machine operator, having a first part operable by the sportsperson, vehicle driver or machine operator and a second part which can be mounted where the user can see it, there being a cableless link between the two parts.

In particular, the present inventors have realised that a reliable stop watch for use inside a vehicle can be made having a first part mounted on the steering wheel which is controlled by the driver and a second part, mounted on the dashboard, there being a cableless link between the two parts.

Accordingly, the present invention provides an accessory for a sportsperson, vehicle driver or machine operator, operable by the sportsperson, driver or operator respectively, comprising:

1. a first part mountable on a part of the vehicle, sporting equipment or machine which is normally held by the sportsperson, driver or operator, comprising control means operable by the sportsperson, driver or operator and transmitter means for transmitting control signals in response to the operation of the control means, and

2. a second part comprising receiving means for receiving signals from the transmitter means and accessory means, controllable by the receiver means, whereby the sportsperson, driver or operator can control the accessory means;

wherein the transmitter means transmits signals to the receiver means by a cableless link.

Hereinafter, the term “operator” will be used to denote the sportsperson, vehicle driver or machine operator. The term “controls” will be used to designate a part of the vehicle, sporting equipment or machine which is normally held by the operator.

With the apparatus of the invention, a simple, small control device can be mounted in exactly the right place for operation by the operator without substantially removing either hand from the controls. However, the body of the accessory device can be mounted easily viewable by the driver. Further, if the accessory is relatively bulky, the present invention allows it not to be mounted on the controls.

The inventors have discovered that cableless link means work sufficiently well over the relatively small distance from controls to fixed parts where the accessory can be placed in view of the operator, whereby reliable operation of the accessory can be obtained.

The accessory may be any suitable accessory. Preferably, the accessory comprises time measuring means, such as a stopwatch. Alternatively, it may comprise a radio, or means for transmitting signals, for example to trackside operators. It may additionally or alternatively comprise a light. Preferably, the accessory means comprises display means for displaying information to the operator.

The present invention is particularly suitable for use by a sportsperson or vehicle driver.

Where the accessory is for use by a driver of a vehicle, the first part is preferably mountable on the steering wheel of the vehicle, where the control means can be operated by the driver, whereby the driver can control the vehicle accessory means.

Where the accessory is for operation by a sportsperson, the first part may be mountable on any suitable sporting equipment, such as a racket, bat, ski poles, water skiing handle or the like. Alternatively, the first part may be mountable on a specialised article for the operator to hold, which may be in the form of a hand held object or a device which may be fixed to a part of the hand, for example a finger or fingers, thumb or the palm of the hand. The apparatus for contacting the hand may comprise a glove, ring or strap. It may be fixed in place by any suitable means, for example zip fasteners, touch and hold fasteners, such as Velcro (trade mark), buckles, laces, adhesive which is compatible with the skin or the like.

Where the accessory is for a sportsperson, the second part is mountable where the sportsperson can see it. Preferably, it should be mountable where the sportsperson can see it without moving their head from their normal direction of view or in a position where the sportsperson will need to look from time to time. For example, the second part may be mountable on sports clothing, for example head gear, belts, trousers, boots etc. The second part may be mountable on sports equipment, such as a board, skis or the like. Any suitable fixing means may be used. The second part may comprise a clamp. It may comprise adhesive parts for adhering to the desired surface. Binding such as tapes may be provided for fixing the second part. The tapes may be secured using Velcro (tade mark) or similar touch and hold fastenings. Permanent fixing such as screws, bolts, nuts etc. may be provided.

Where the accessory is a vehicle accessory, the first part may be mountable to the steering wheel by any suitable means. For example, it may comprise a clamp. It may comprise adhesive parts for adhereing to the steering wheel. Bindings such as tapes may be provided for fixing the first part to the steering wheel. The tapes may be secured for example using Velcro (trade mark) or similar touch and hold fastenings. Permanent fixings such as screws, bolts, nuts etc. may be provided. Preferably, the first part is mountable on the rim of a steering wheel.

In all aspects, the control means may comprise any suitable hand or finger operated controls, such as buttons. Preferably, a relatively small number of control means are provided to simplify operation.

When the accessory comprises a stop watch there may be a START/STOP/CLEAR button or buttons.

Other controls may be provided, for example to provide a countdown function.

The transmitter means may comprise any suitable transmitter. The cableless link between the transmitter means and the receiver means may operate using radio frequency, microwave, infrared, ultrasound or any other suitable means. Infrared or ultrasound are preferred. Suitable transmitter means are known in the field of television remote control devices. The person skilled in the art will have no difficulty in selecting a suitable design of transmitter means and receiver means.

Suitably, the transmitter means will comprise a power source such as a battery to power the transmitter means.

Preferably, the first part is configured so that, in use, the control means is positioned so that it will not be accidently actuated by normal operation but is easy operate, for example with a thumb or finger without removing a hand from the controls.

In the case of a vehicle accessory, the control means is preferably positioned about 1 to 8 cm, more preferably 2 to 5 cm inside or outside the rim of the steering wheel. Preferably, it is positioned in the plane of the steering wheel rim.

In all aspects of the invention, the cableless link should be capable of transmitting signals successfully over the normal maximum separation of the first and second part. In many cases, it will be acceptable if the calbeless link is operable over a distance of no more than 2 meters, or even over a distance of no more than 1 meter. It is preferred that the cableless link should not be operable over too great a distance, in order to avoid cross-talk between different sportspersons, vehicle drivers or machine operators which could create accidents.

In the case of a vehicle accessory, the second part is for mounting adjacent the steering wheel. By adjacent, it is meant that the second part is within a given distance of the transmitting means, for example less than 1 meter. In practice, this means that the second part is preferably designed for mounting on a part of the vehicle interior, preferably the dashboard, windscreen, steering wheel column or other part of the vehicle in easy view from the driving position. The second part may comprise any suitable means for fixing to such surfaces. For example, mechanical clamps may be used. For example nuts and bolts or screws for permanent engagement with the vehicle structure may be used, but these are not preferred. Adhesive surfaces may be provided on the second part for attaching it to for example, the dashboard. Preferably, the adhesive allows the second part to be removed if necessary. The skilled person will be aware of suitable types of adhesive material which can be used.

In all aspects of the invention, the second part comprises a receiver means which can receive signals emitted by the transmitter means and convert them into electrical signals for operating the accessory means. The person skilled in the art will be aware of suitable designs of receiver means which can be used in this way.

The accessory means may comprise display means.

The display means may display any suitable information, for example time elapsed, time remaining (e.g. a countdown function), signal lights (for example red and green for stop and go respectively) or any other suitable information. The accessory may be programmed to indicate the exact time at which a driver should start, by providing a countdown followed by a green light for go. There may be a time delay equal to normal driver reaction time to give the driver time to prepare. The time delay may be 5-10 seconds.

The accessory may incorporate a memory for storing previously recorded information, for example dates, lap times, average speeds etc.

The accessory may comprise any other suitable components, for example a printer for recording times logged, as described in GB 2 042 775. It may comprise additional manual control devices, such as buttons, which can be operated under less strenuous conditions. For example, at the end of a run, buttons may be pressed to store measured times in a memory in the accessory.

In the case of a vehicle accessory the present invention may be used in any suitable type of vehicle, for example, cars, lorries, boats (for example speed boats), bicycles, e.g. motorcycles, aeroplane, or any other type of vehicle in which the driver needs to keep the hands on the control means. The present invention may find application in many sports, for example, skiing, snow boarding, skating, rowing, parachuting etc.

In each case, the first part shall be mountable on any part which is normally held by the operator. In the case of a motorcycle or bicycle, this will include the handle bars. In the case of an aeroplane, this will include the stick.

The present invention will be described further by way of example only with reference to the accompanying drawings, in which:

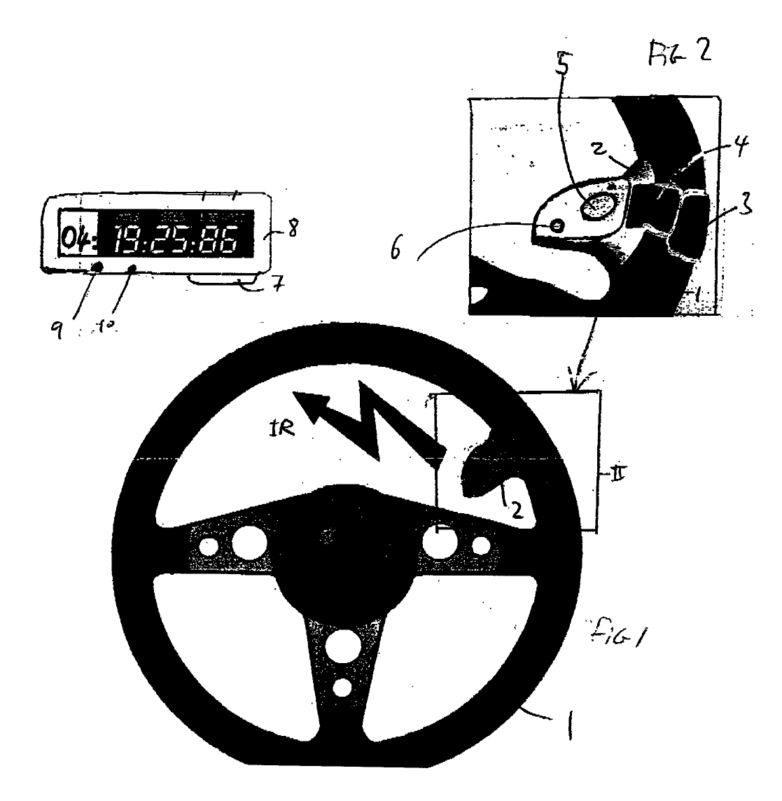

FIG. 1 is a schematic illustration of a vehicle accessory according to the present invention.

FIG. 2 is a part enlarged view of the first part shown in FIG. 1.

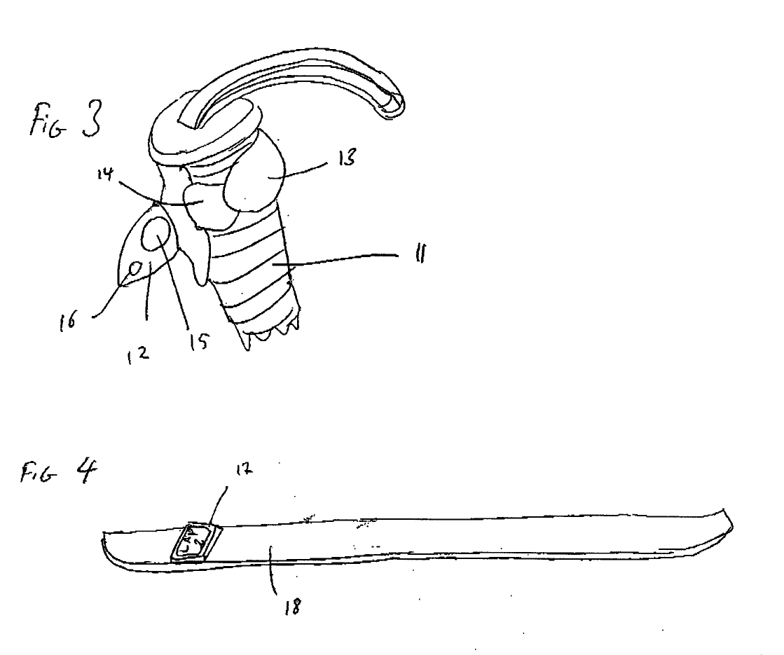

FIG. 3 is a schematic illustration of the first part of an accessory for a sportsperson, mounted on the handle of a ski pole.

FIG. 4 is a schematic illustration of the second part of an accessory according to the present invention, mounted on the front part of a ski.

FIG. 1 shows a schematic view of a vehicle accessory according to the present invention mounted to the steering wheel of a vehicle.

A steering wheel 1 of a vehicle is shown. The rest of the vehicle is omitted, for clarity. A first part 2 of a vehicle accessory according to the present invention is shown mounted on the steering wheel by mounting means.

The first part is shown in more detail in the part enlarged section shown in FIG. 2. FIG. 2 is an enlargement of the part described by box II.

As shown in FIG. 2, the first part 2 is fixed to the steering wheel 1 by a clamp comprising parts 3 and 4 which grip the steering wheel 1. The first part 2 comprises a first button 5. At a first press, a START signal is given. At a further press, a STOP signal is given at a third press, a CLEAR signal is given. There is a second button 6 which switches on a light in the second part, for night operation. The first part comprises a transmitter (not shown in detail) for transmitting infrared signals representative of commands given in response to operation by the driver of the button 5 or 6. The button 5 lies in the plane of the steering wheel rim about 3 cm inside the rim, for optimum ease of operation.

A second part of the apparatus is shown mounted adjacent (less than 1 meter away from) the steering wheel. The second part comprises a receiver 7 shown schematically, for receiving infrared signals transmitted by the transmitter of the first part 2. The receiver 7 gives electrical signals for operating the accessory 8 which comprises a timing device. The timing device records the time in hours, minutes, seconds, tenths and hundreds of seconds following a START signal generated by pressing button 5 once. When button 5 in pressed again, the stop watch 8 stops recording the time elapsed. The accessory 8 comprises further control buttons 9 and 10. these duplicate buttons 5 and 6 respectively, allowing operation of the system by a second occupant of the vehicle or in the absence of the first part 2.

FIG. 3 shows a first part of a sportsperson accessory, according to the present invention, fixed to the handle of a ski pole (11). The first part (12) comprises clamping parts (13) and (14) which comprise touch and hold fastening such as Velcro (trade mark). The first part (12) further comprises a first button (15). At a first press, a start signal is given. At a further press, a stop signal is given and at a third press, a clear signal is given. A further button (16) switches on a light. The first part (12) comprises a transmitter (not shown) for transmitting infrared signals representative of commands given in response to operation by the sportsperson by the button (15).

A second part of the apparatus (17) is shown mounted at the front end of a ski, where it will be visible to the operator. The second part comprises a receiver for signals emitted by the first part (12) and a display for displaying information in response to the commands given by the first part (in this case, lap number).

The present invention has been described above by way of example only and modifications can be made within the invention. The present invention also consists in any individual features described or implicit herein or shown or implicit in the drawings or any combination of such features or any generalisation of any such features or combination.

1. An accessory for an operator selected from the group consisting of a sportsperson, vehicle driver or machine operator, operable by said operator, comprising:
1) a first part, mountable on a part of an object selected from the group consisting of a vehicle, piece of sports equipment or machine which is normally held by said operator, said first part comprising control mean operable by said operator and transmitter means, for transmitting control signals, in response to operation of said control means, and
2) a second part, comprising receiver means for receiving signals from said transmitter and accessory means, controllable by said reciever means, whereby said operator can control said accessory means,
wherein said transmitter means transmits signals to said receiver means by a cableless link.

2. An accessory according to claim 1, being an accessory for a sportsperson.

3. An accessory according to claim 1, being a driver operable vehicle accessory, said first part of said accessory being mountable on a steering wheel of a vehicle, whereby said control means is operable by said driver, said second part being mountable adjacent said steering wheel, whereby said driver can control said vehicle accessory means.

4. An accessory according to claim 1 wherein said cableless link is selected from the group consisting of a radio frequency, microwave, infrared or ultrasound link.

5. A driver operable vehicle accessory according to claim 3, wherein the control means is mountable on a steering wheel of a vehicle, so that it is positioned about 1 to 8 cm outside the rim of said steering wheel.

6. An accessory according to claim 1, wherein said transmitter means is capable of transmitting signals to said receiver means at a distance of up to 2 meters.
